(19) United States
(12) Patent Application Publication
(10) Pub. No.: US 2012/0085088 A1
(43) Pub. Date: Apr. 12, 2012

(54) Gravity buoyancy generator

(76) Inventor: Walid Aboelhaggag Ibrahim Ahmed Zidan, Cairo (EG)

(21) Appl. No.: 12/923,771

(22) Filed: Oct. 7, 2010

(51) Int. Cl. F03B 13/12; F03B 17/04

(52) U.S. Cl. 60/495; 415/916

(57) ABSTRACT

An apparatus and method to generate perpetual energy from gravity or any other energy with the same effect by a rotary cylindrical system comprising of three subsystems (loads, middle and liquid) and depending on the effect of gravity on Weight and density of materials used. The system is mainly aiming to transform the gravity energy to buoyancy energy and making the effect of the buoyancy energy grater than the effect of gravity energy on the balance of the whole system. The system is depending on placing the center of the loads as a subsystem approximately or identical with the axes of the cylindrical system to reduce the gravity effect on the balance of the cylindrical system to zero or approximately zero when the loads are not on place to effect on the balance of the system by gravity and when the loads are on place to effect on the balance of the system by gravity energy it transfers the required magnitude of gravity energy directly from the center of the system (by little small load deviation from the cylinder axes and small effect on the balance of the system) to the middle subsystem which will interact with the liquid subsystem at the circumference of the system and produce buoyancy energy and according to the distance between the axes of the system and the circumference of the system the effect and torque of the buoyancy energy will be grater than the effect and torque of the loads subsystem deviation on the balance of the whole system and the overbalance energy produced will rotate the loose cylindrical system about its axes.

### BACKGROUND OF THE INVENTION

The present invention relates to an energy producing apparatus and method utilizing the gravity and buoyancy forces. Such examples are seen in U.S. Pat. No. 430,333, U.S. Pat. No. 4,718,232, U.S. Pat. No. 5,944,480, U.S. Pat. No. 3,984,698, U.S. Pat. No. 4,317,046, U.S. Pat. No. 4,674,281, U.S. Pat. No. 4,726,188, U.S. Pat. No. 5,996,344 and U.S. Pat. No. 3,194,008.

These ideas used to create a kinetic circular system to produce energy depending on making the gravity effect directly on the system movable parts which is effecting on the system balance to change these part's positions and make one of the two halves of the circular system more heavier than the other by moving these part's farther from or closer to the center of the system to create imbalanced status on the whole system. While the moving parts effecting on the system balance are still installed on a fixed system with a fixed centre.

These ideas have failed or didn't produce efficient energy because:
1—The system used to have number of units that are depending on each other and each unit is effecting on the balance of the system.
2—Every unit on the system didn't have an operation cycle which starts from the unaffecting status on the system passing through the effecting status and returning to unaffecting status again in the end of the unit cycle otherwise it used to be in action status and effecting on the system all the time.
3—These ideas used to depend on the effect of gravity on the Wight and density of the materials in one system only and didn't gather a multiple different subsystems assembled in one system to interact with each other to produce energy.
4—Unintentionally or intentionally these ideas used to depend on creating another hypothetical center for the moving parts effecting on the system balance to imbalance the system.
5—The moving parts effecting on the system balance used to move along the distance between the nearest point to the center and the circumference of the system and never be at the center of the system and it always has an effect on the balance of the system in all positions of the system.

### BRIEF SUMMARY OF THE INVENTION

A method and apparatus to generate perpetual energy from gravity or any other energy with the same effect by a rotary cylindrical system comprising of three subsystems:
A—The loads subsystem: where's at the center of the wheel system and it should be a very high density material (Ex. Iron). But it must weight more than the liquid subsystem.
B—The liquid subsystem: This is a liquid (fluid) at the boundary of the whole system (Ex. Water).

And its density must be higher than the density of the middle subsystem.
C—The middle subsystem: it can be tangible or intangible material (Ex. air) and should have the lowest density and weight to float in the liquid subsystem. It links and interacts with the two other subsystems by receiving the direct effect from the loads subsystem and removing some of the liquid subsystem to create the buoyancy energy.

The system is depending on the effect of gravity or any other energy with the same effect on Weight and density of materials used. The system is divided into an equal unit and mainly aiming to transform the gravity energy to buoyancy energy and making the effect of the buoyancy energy grater than the effect of energy used on the balance of the whole system. The system is depending on placing the center of the loads as a subsystem approximately or identical with the axes of the cylindrical system to reduce the gravity effect on the balance of the cylindrical system to zero or approximately zero when the loads are not on place to effect on the balance of the system by gravity and when the loads are on place to effect on the balance of the system by gravity energy the next equation will be applied:
1. The loads subsystem impact and weight on the middle subsystem is greater than the impact and weight of the liquid subsystem.

And the first step will be executed which is: The loads subsystem will transfers the required magnitude of gravity energy directly from the center of the system (by little small load deviation from the cylinder axes and small effect on the balance of the system) to the middle subsystem through a pole connecting the two subsystems whereas the middle subsystem will effect and be pushed into the liquid subsystem and the middle and the liquid subsystems will interact at the circumference of the system and the liquid subsystem will be removed up over the middle subsystem (middle subsystem is very low density material and can float in the liquid subsystem) and produce buoyancy energy and according to the distance between the axes of the system and the circumference of the system whereas the middle and liquid subsystems exist and according to the equation of:
2—The direct distance between the middle subsystem and the axis of the system must generate torque of buoyancy energy on the axes of the system greater than the generated torque from the deviation of the loads subsystem considering the longest direct distance between the center of the load deviation and the axis of the system and also considering the loads diameter.
3—The removed liquid (fluid) by the middle subsystem and over the middle subsystem from the beginning to the end of unit cycle must have weight and effect on the axis of the system (considering the distance between the middle subsystem and the system axis which is the horizontal distance and parallel to the base line) more than the weight and effect of the deviation of the loads subsystem on the axis of the system (considering the distance between the center of the loads deviation and the axis of the system which is the horizontal distance and parallel to the base line and also considering the loads diameter).

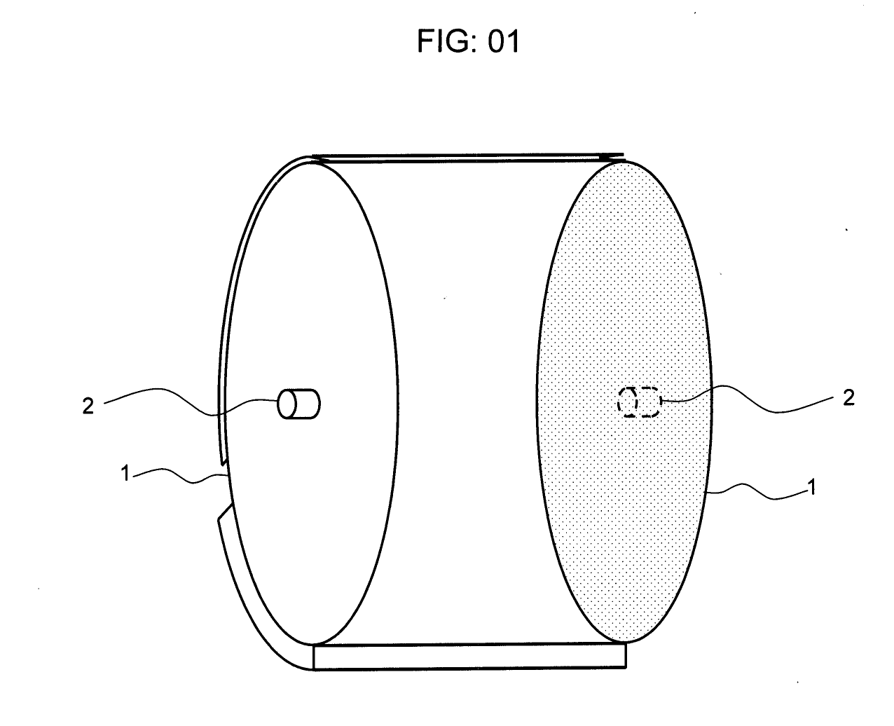

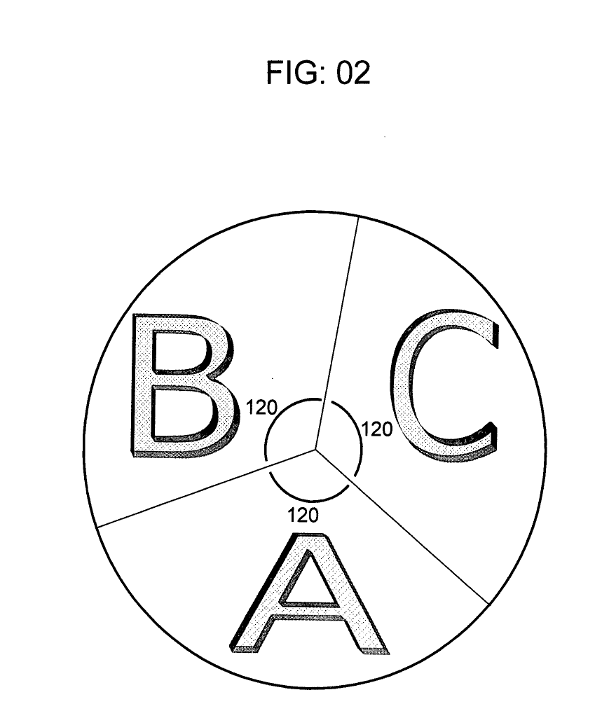

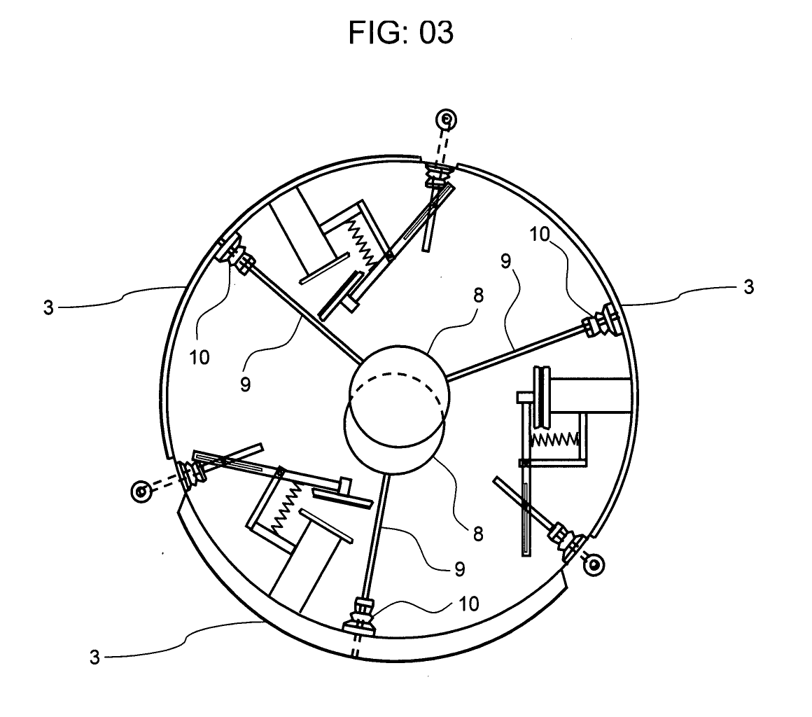

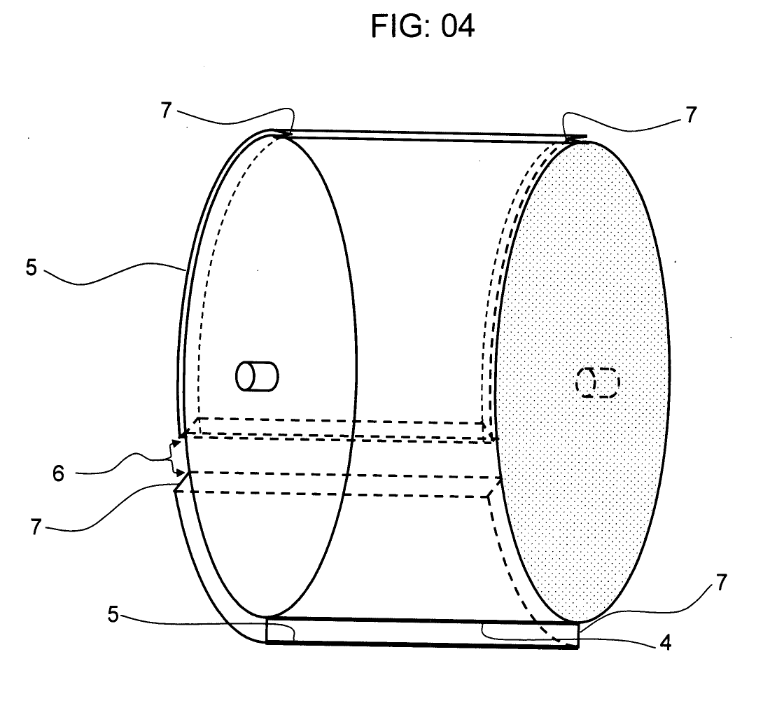

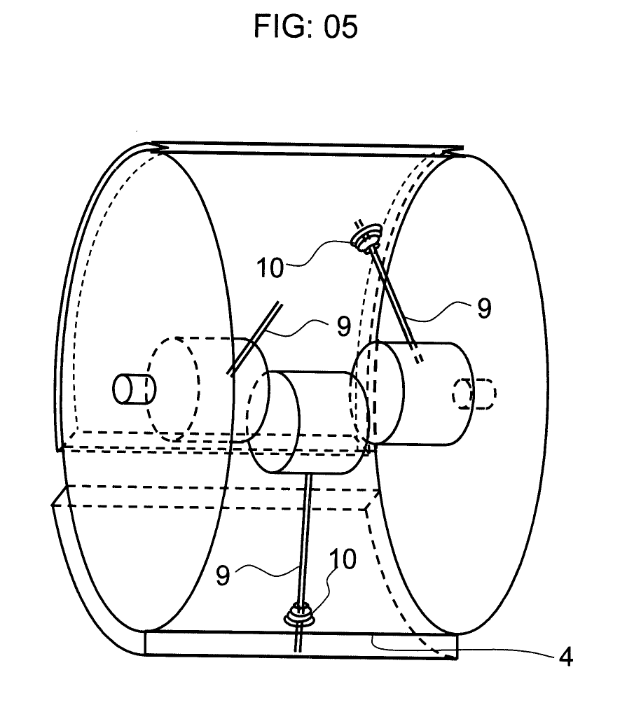

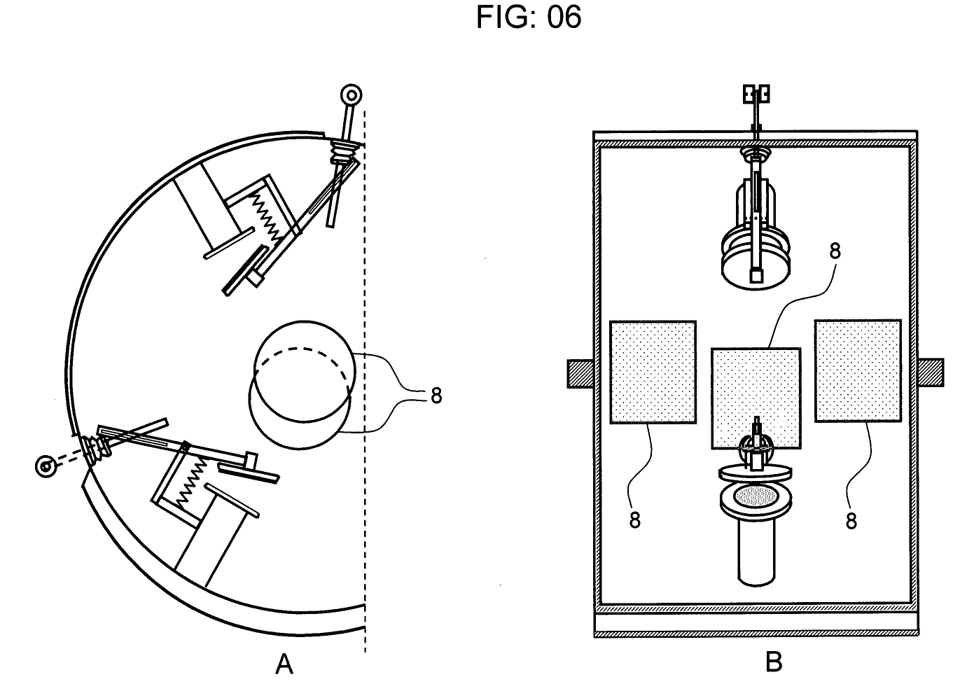

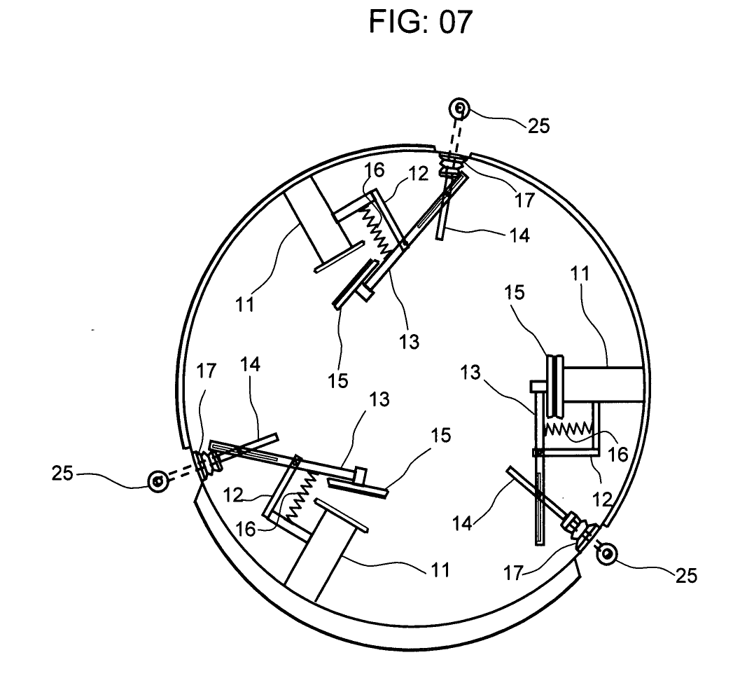

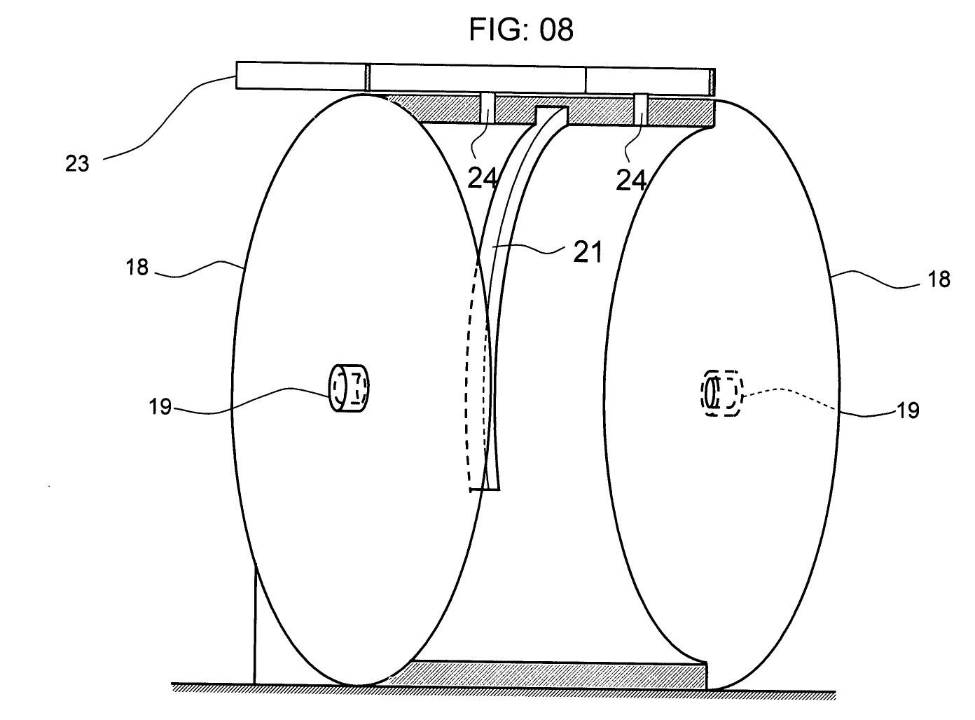

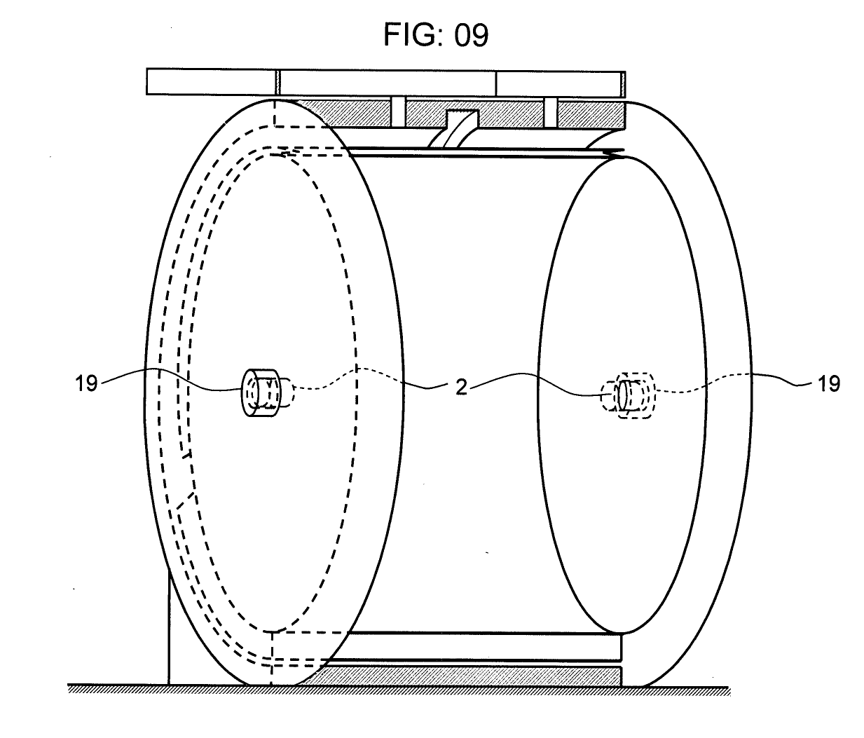

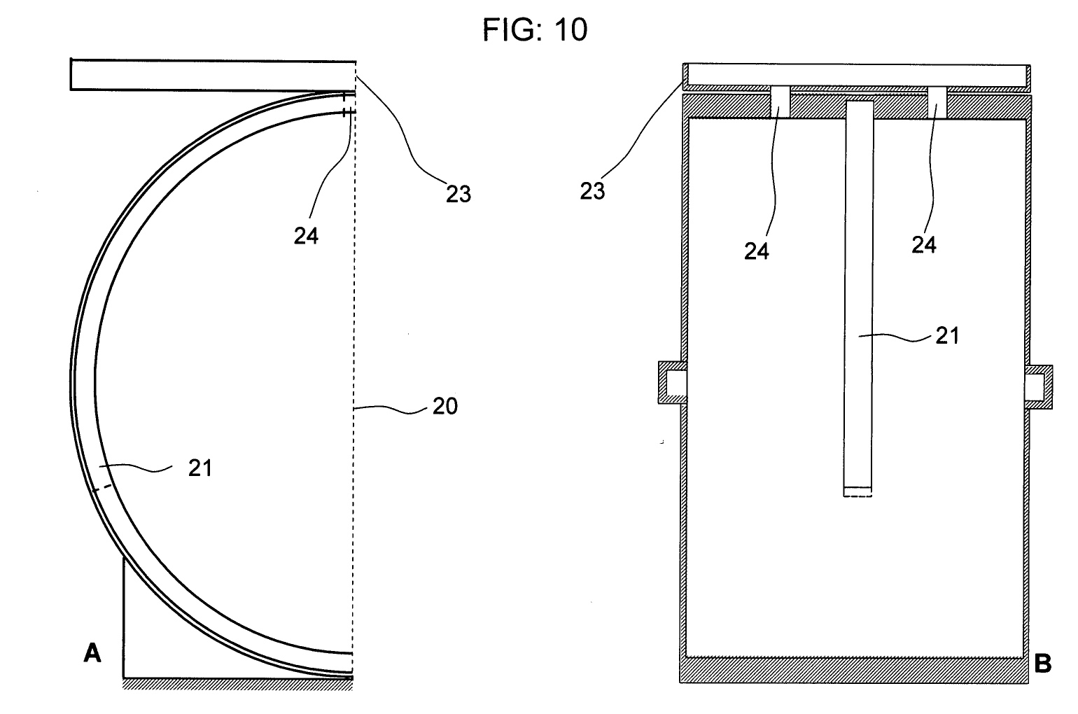

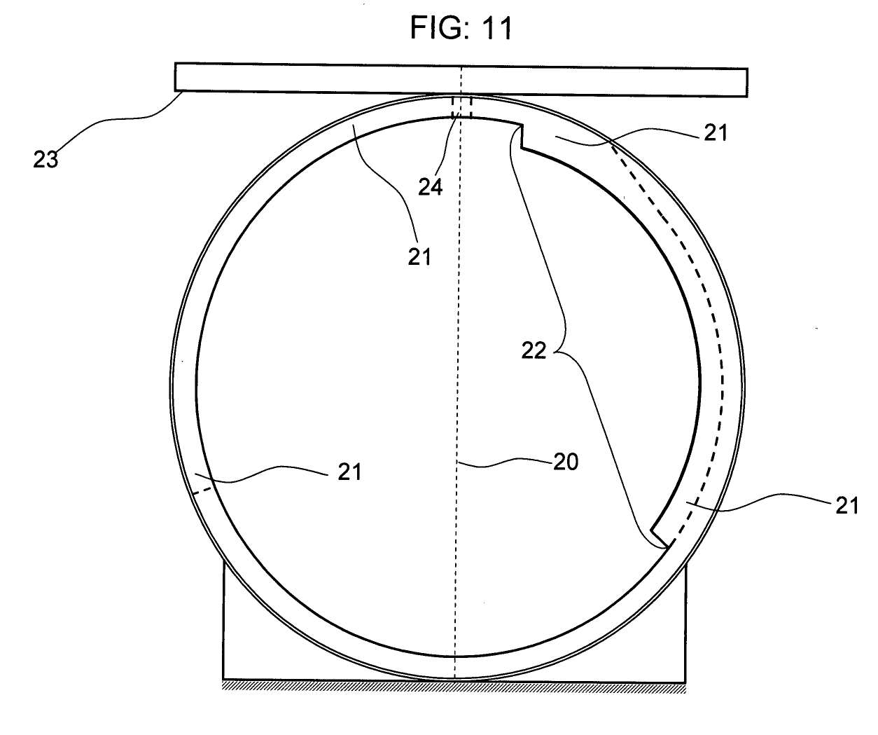

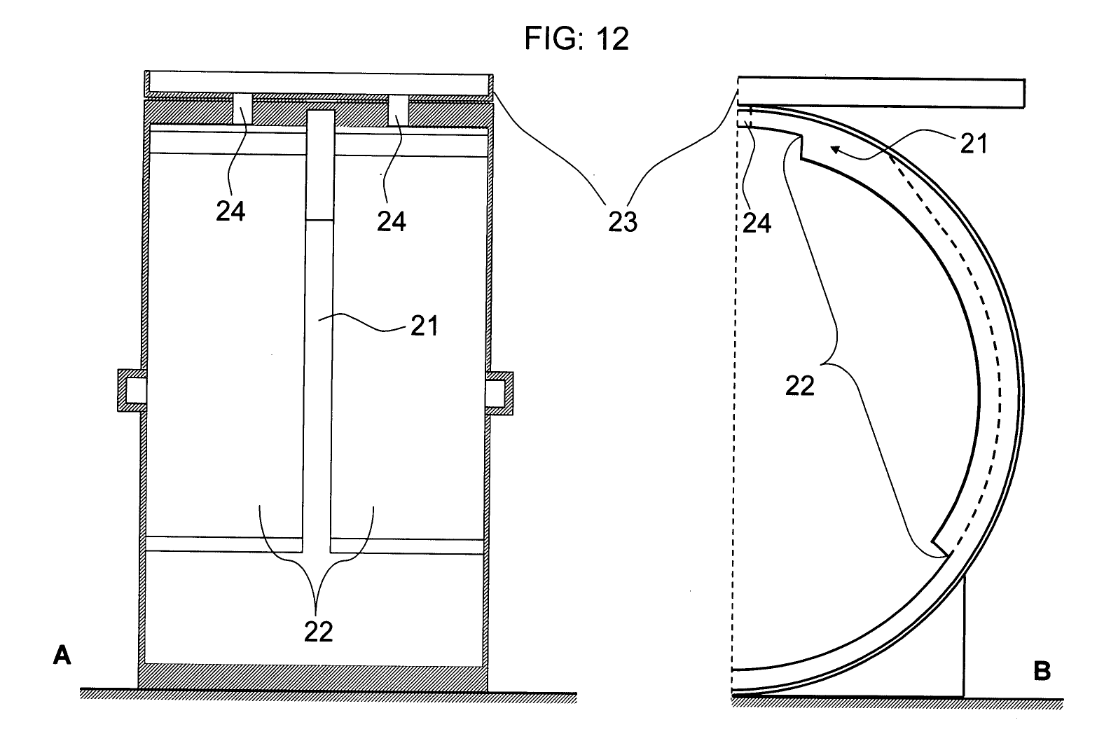

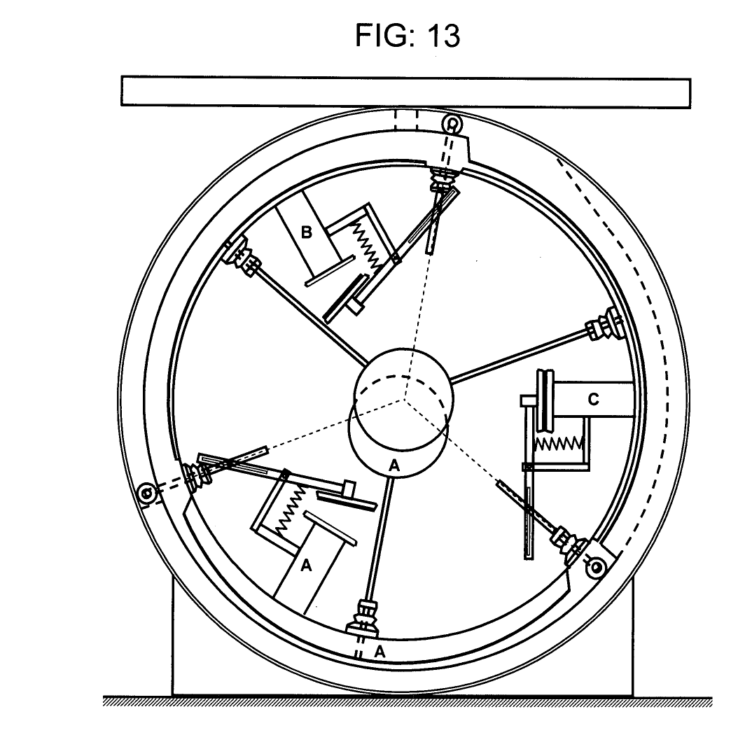

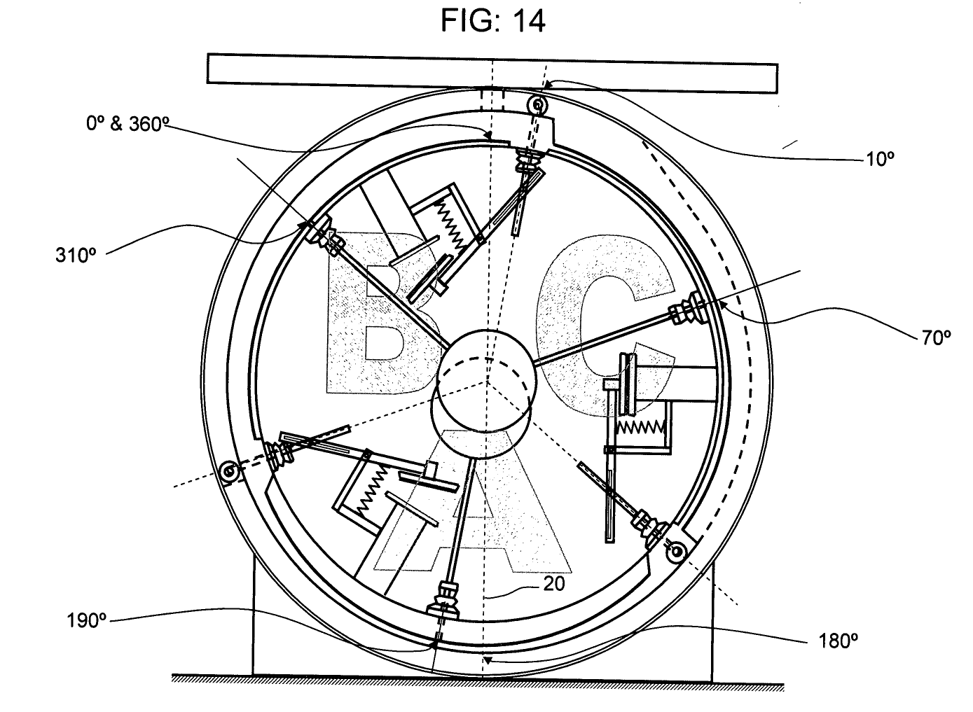

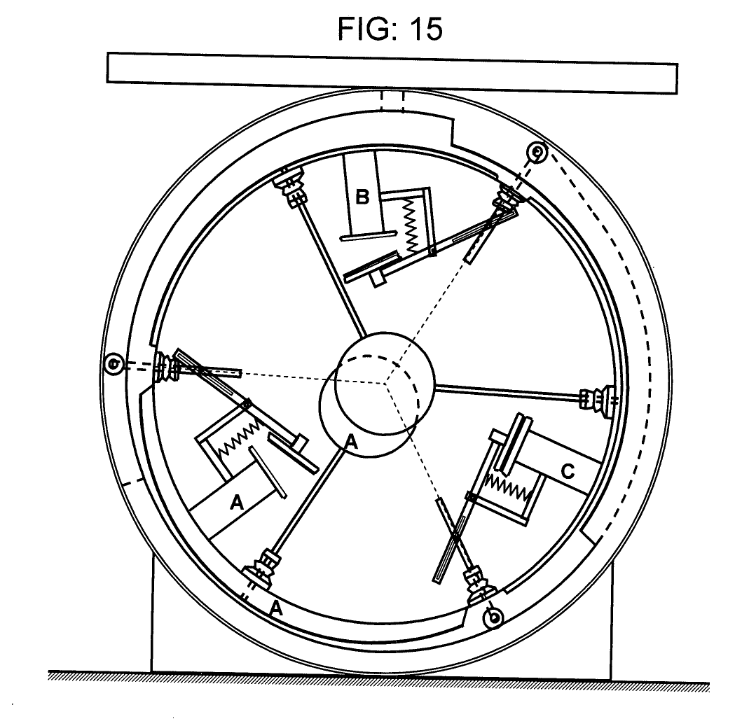

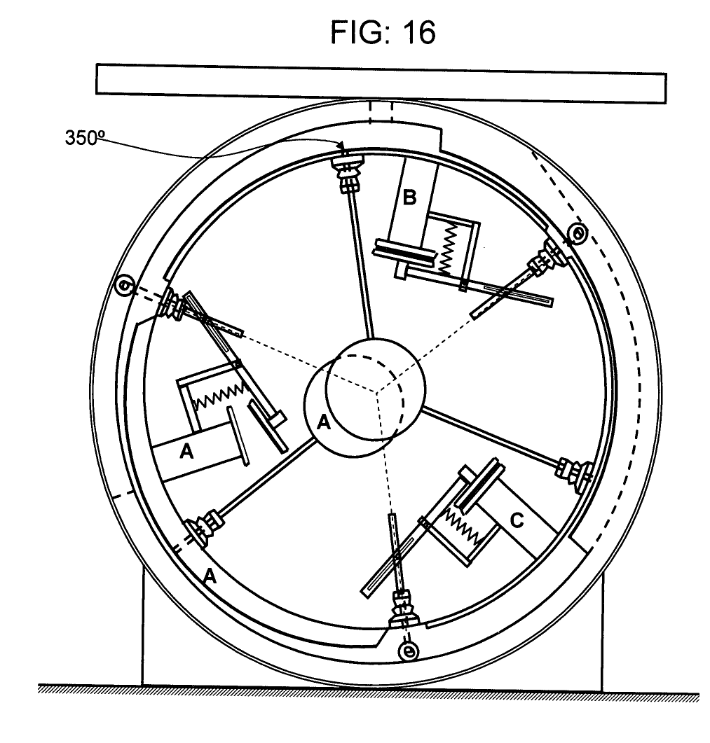

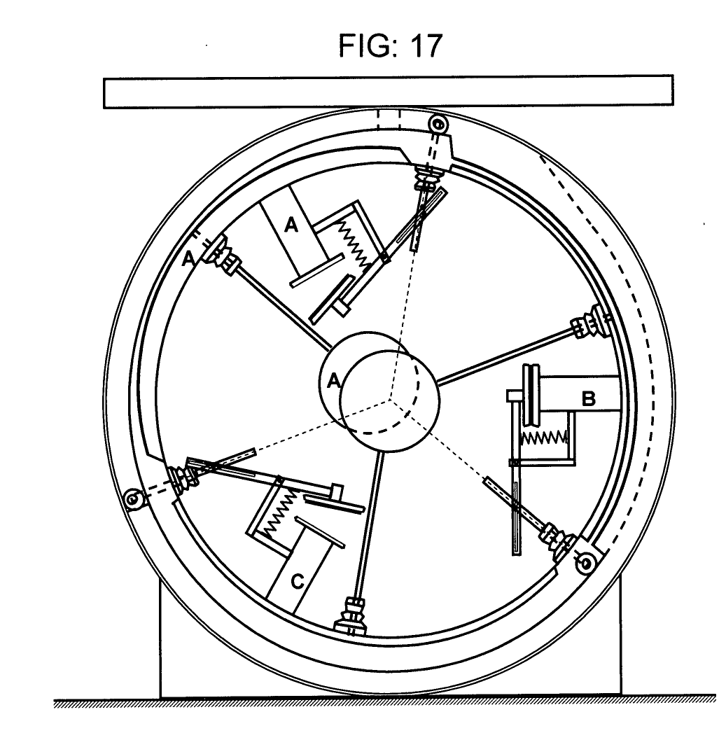

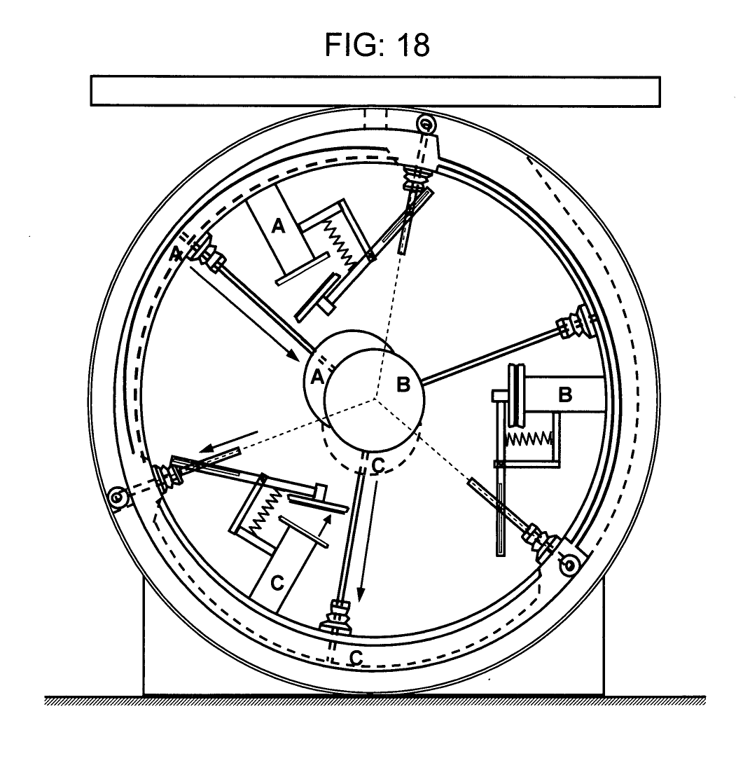

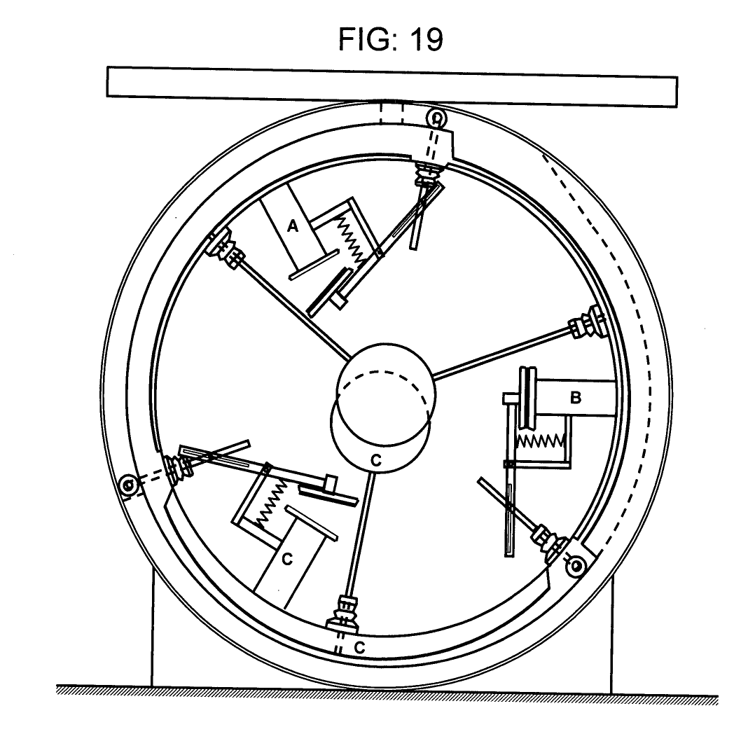

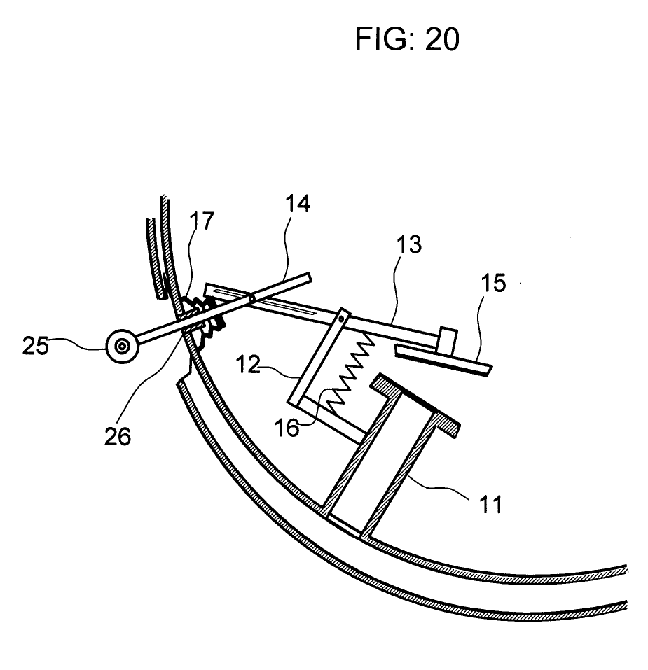

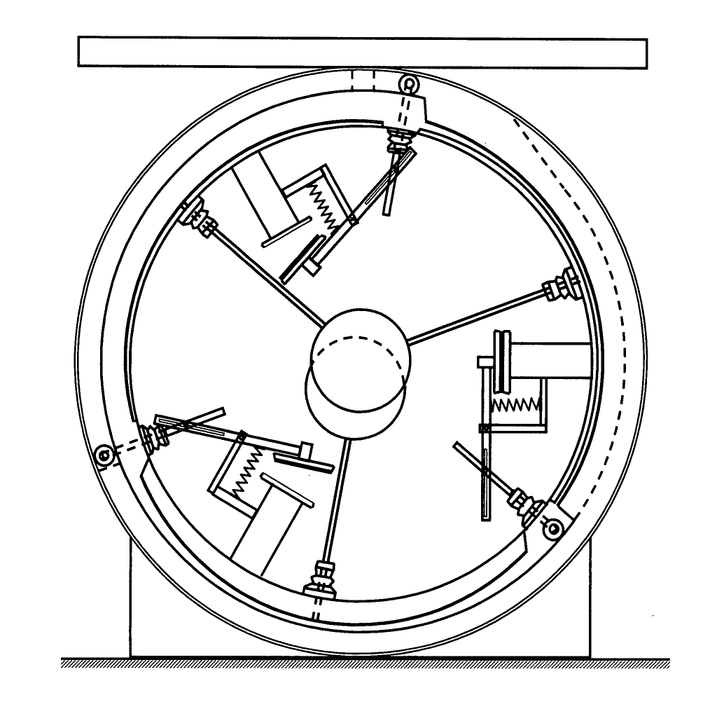

The second step will be executed which is: The effect (torque) of the buoyancy energy will be grater than the effect (torque) of the loads subsystem deviation on the balance of the whole system and the overbalance energy produced will rotate the loose cylindrical system about its axes.

Wherefore this system:
1—Has number of units that have a sequential effect on the whole system.
2—Every unit on the system have an operation cycle which starts from the unaffecting status on the system passing through the effecting status and returning to unaffecting status again in the end of the unit cycle.
3—Depend on the effect of gravity on the Wight and density of the materials in multiple different subsystems assembled in one system to interact with each other to produce energy.
4—The whole system has one center only.
5—The loads subsystem is at the center of the system and balanced with it (as if its not existed) when its not on the place to effect on the balance of the system by gravity; and it move in a very small distance from the center toward the circumference to transfer most of the gravity energy on the loads to the boundaries of the system with small effect on the balance of the system.
6—The system transforms the gravity energy to buoyancy energy.
   Other general advantages of the invention:
1—The invention provides a very cheap perpetual source of energy.
2—The invention is 100% friendly with the environment.
3—The wide use of the invention will contribute in the reduction of the global worming.
4—The invention can be used at any time any place in the universe nonstop.
5—The invention can be produced in different diminutions.

| Number | | | Drawing |
|---|---|---|---|
| of FIG. | part | Brief Description of the several views of drawing | sheet |
| FIG. 1 | | Horizontal elevation with Oblique to the right showing sectional | 01 |
| | | elevation of the internal cylinder with air tanks and the full solid walls | |
| | | and the constructed hubs on the soled walls. | |
| FIG. 2 | | Horizontal elevation of the internal cylinder showing the Hypothetical | 02 |
| | | elevation of the internal cylinder. | |
| FIG. 3 | | Horizontal elevation of the internal cylinder without the solid walls | 03 |
| | | showing the components of the internal cylinder (air tanks, valves, | |
| | | loads) | |
| FIG. 4 | | Horizontal elevation with Oblique to the right showing sectional | 04 |
| | | elevation of the internal cylinder with one opened air tanks and one | |
| | | closed air tank and the full solid walls and the constructed hubs on | |
| | | the soled walls. | |
| FIG. 5 | | Horizontal elevation with Oblique to the right showing sectional | 05 |
| | | elevation of the internal cylinder with air tanks and the full solid walls | |
| | | and the constructed hubs on the soled walls. And the loads position | |
| | | inside the internal cylinder with the loads pole passing Through the | |
| | | Resizable Insulator and the internal cylinder and installed in the | |
| | | second wall of the air tank. | |
| FIG. 6 | A | Horizontal elevation of the internal cylinder without the solid walls | 06 |
| | | showing portion of the internal cylinder and the components of that | |
| | | internal cylinder portion (different air tank position, opened valves | |
| | | and different loads position) | |
| FIG. 6 | B | Horizontal sectional elevation of the right side of the internal cylinder | 06 |
| | | showing the components of that internal cylinder (different air tank | |
| | | position, opened valves position and different loads position) | |
| FIG. 7 | | Horizontal elevation of the internal cylinder without the solid walls | 07 |
| | | and the loads showing the internal cylinder's different air tank | |
| | | position and opened and closed air valves. | |
| FIG. 8 | | Horizontal elevation with Oblique to the right showing sectional | 08 |
| | | elevation of the external cylinder with full solid walls and the | |
| | | constructed hubs on the soled walls and the cavity of the Valves | |
| | | control path and the Water container over the external cylinder. | |
| FIG. 9 | | Horizontal elevation with Oblique to the right showing sectional | 09 |
| | | elevation of the external and internal cylinders with full solid walls | |
| | | and the constructed hubs on the soled walls of the two cylinders | |
| | | installation. | |
| FIG. 10 | A | Horizontal front elevation of the external cylinder without the solid | 10 |
| | | walls showing the front left side of the external cylinder and the | |
| | | components of the external cylinder (valves control path and | |
| | | water container) | |
| FIG. 10 | B | Horizontal sectional elevation of the right side of the external | 10 |
| | | cylinder showing the components of the external cylinder (valves | |
| | | control path and water container) | |
| FIG. 11 | | Horizontal front elevation of the external cylinder without the solid | 11 |
| | | walls showing the front of the external cylinder and the components | |
| | | of the external cylinder (valves control path, Protrusion and water | |
| | | container) | |
| FIG. 12 | A | Horizontal sectional elevation of the right side of the external | 12 |
| | | cylinder showing the components of the external cylinder (valves | |
| | | control path, protrusion and water container). | |
| FIG. 12 | B | Horizontal front elevation of the external cylinder without the solid | 12 |
| | | walls showing the front left side of the external cylinder and the | |
| | | components of the external cylinder (valves control path, protrusion | |
| | | and water container). | |
| FIG. 13 | | Horizontal front elevation of the internal cylinder installed inside the | 13 |
| | | external cylinder and without the solid walls of the two cylinders | |
| | | showing the components of the internal cylinder (different air tank | |
| | | position, opened and closed valves and different loads position) and | |
| | | the internal cylinder is divided into three equal portions A, B and C | |
| | | by three dashed lines intersected at the center of the two cylinders | |
| | | and the elevation also shows the components of the external | |
| | | cylinder (valves control path, protrusion and water container). The | |
| | | elevation is showing the starting position of the operation cycle of | |
| | | the portion A (unit A). | |
| FIG. 14 | | Horizontal front elevation of the internal cylinder installed inside the | 14 |
| | | external cylinder and without the solid walls of the two cylinders | |
| | | showing the components of the internal cylinder (different air tank | |
| | | position, opened and closed valves and different loads position) and | |
| | | the internal cylinder is divided into three equal portions A, B and C | |
| | | by three dashed lines intersected at the center of the two cylinders | |
| | | and the elevation also shows the components of the external | |
| | | cylinder (valves control path, protrusion and water container) which | |
| | | is divided in two halves by the length of the perpendicular diameter | |
| | | at the base of the external cylinder by dashed line.The elevation is | |
| | | showing the starting position of the operation cycle of the portion | |
| | | A (unit A) and the degree angles of each portion of the internal | |
| | | cylinder and the degree angles of the perpendicular diameter | |
| | | dividing the external cylinder. | |
| FIG. 15 | | Horizontal front elevation of the internal cylinder installed inside the | 15 |
| | | external cylinder and without the solid walls of the two cylinders | |
| | | showing the components of the internal cylinder (different air tank | |
| | | position, opened and closed valves and different loads position). and | |
| | | the internal cylinder is divided into three equal portions A, B and C | |
| | | by three dashed lines intersected at the center of the two cylinders | |
| | | and the elevation also shows the components of the external | |
| | | cylinder (valves control path, protrusion and water container). The | |
| | | elevation is showing the rotation of the internal cylinder about its | |
| | | axes of the operation cycle of the portion A (unit A). | |
| FIG. 16 | | Horizontal front elevation of the internal cylinder installed inside the | 16 |
| | | external cylinder and without the solid walls of the two cylinders | |
| | | showing the components of the internal cylinder (different air tank | |
| | | position, opened and closed valves and different loads position) and | |
| | | the internal cylinder is divided into three equal portions A, B and C | |
| | | by three dashed lines intersected at the center of the two cylinders | |
| | | and the elevation also shows the components of the external | |
| | | cylinder (valves control path, protrusion and water container). The | |
| | | elevation is showing the rotation of the internal cylinder about its | |
| | | axes of the operation cycle of portion A (unit A) at the angles degree | |
| | | point where the valve of portion B (unit B) will be closed. | |
| FIG.17 | | Horizontal front elevation of the internal cylinder installed inside the | 17 |
| | | external cylinder and without the solid walls of the two cylinders | |
| | | showing the components of the internal cylinder (different air tank | |
| | | position, opened and closed valves and different loads position) and | |
| | | the internal cylinder is divided into three equal portions A, B and C | |
| | | by three dashed lines intersected at the center of the two cylinders | |
| | | and the elevation also shows the components of the external | |
| | | cylinder (valves control path, protrusion and water container). The | |
| | | elevation is showing the ending position of the operation cycle of the | |
| | | portion A (unit A). | |
| FIG. 18 | | Horizontal front elevation of the internal cylinder installed inside the | 18 |
| | | external cylinder and without the solid walls of the two cylinders | |
| | | showing the components of the internal cylinder (different air tank | |
| | | position, opened and closed valves and different loads position) and | |
| | | the internal cylinder is divided into three equal portions A, B and C | |
| | | by three dashed lines intersected at the center of the two cylinders | |
| | | and the elevation also shows the components of the external | |
| | | cylinder (valves control path, protrusion and water container). The | |
| | | elevation is showing the ending position of the operation cycle of the | |
| | | portion A (unit A), the starting position of the operation cycle of the | |
| | | portion C (unit C) and the sequence of actions of portion A and C. | |
| FIG. 19 | | Horizontal front elevation of the internal cylinder installed inside the | 19 |
| | | external cylinder and without the solid walls of the two cylinders | |
| | | showing the components of the internal cylinder (different air tank | |
| | | position, opened and closed valves and different loads position) and | |
| | | the internal cylinder is divided into three equal portions A, B and C | |
| | | by three dashed lines intersected at the center of the two cylinders | |
| | | and the elevation also shows the components of the external | |
| | | cylinder (valves control path, protrusion and water container). The | |
| | | elevation is showing the ending position of the operation cycle of the | |
| | | portion A (unit A) and the starting position of the operation cycle of | |
| | | the portion C (unit C). | |
| FIG. 20 | | Horizontal sectional elevation showing air valve components. | 20 |

| line # | Description of the indicating elements lines of drawing |
|---|---|
| 1 | Solid walls of Internal cylinder. |
| 2 | Hubs of Internal cylinder. |
| 3 | Air tanks. |
| 4 | Air tanks First side which is the outer surface of the internal cylinder. |
| 5 | Air tanks The second side. |
| 6 | Adequate space is left if necessary between the tanks to allow the movement of the |
| | valve's arm2. |
| 7 | Air tanks Four other sides. |
| 8 | Load. |
| 9 | Pole. |
| 10 | Pole Resizable Insulator. |
| 11 | Valve body. |
| 12 | Valve body (L) shaped carrier arm. |
| 13 | Valve Arm 1. |
| 14 | Valve Arm 2. |
| 15 | Valve Piston. |
| 16 | Valve spring. |
| 17 | Valve Resizable Insulator. |
| 18 | External cylinder solid wells. |
| 19 | Two hubs of External cylinder |
| 20 | Perpendicular line dividing the external cylinder. |
| 21 | Valves control path. |
| 22 | Protrusion of the external cylinder. |
| 23 | Water container. |
| 24 | Pipe of the water container. |
| 25 | Wheel of valve Arm 2. |
| 26 | Tube installed on the passage of the arm2. |

### DETAILED DESCRIPTION OF THE INVENTION

Section 1: The Components and the Assembly of the Invention

### 1—Internal Cylinder:

Is located within the external cylinder, it's a rotational cylinder on its axis and contains all moving parts of the invention. The cylinder diameter is equal at all points (the diameter of the internal cylinder is determined according to equation 2 and 3 of section 2) and front and rear mouths of the cylinder are parallel and vertical on the body of the cylinder and closed by two solid walls (line 1 in FIG. 1). Two hubs of this cylinder is constructed on the walls from outside and at the center of the cylinder axis (line 2 in FIG. 1) and connected to the external cylinder from the inner side of the walls of the external cylinder and also on its axis point (the design of the external cylinder will be explained in paragraph 2 of section 1) to allow the internal cylinder rotation around its axis, which is the axis of external cylinder also and this axis does not pass within the Internal cylinder (FIG. 1). Internal cylinder must be well balanced about its axes unless an external force effect on its balance. This cylinder is divided theoretically and not actually from the center of the cylinder reaching to the circumference of the cylinder into three equal sections (120° each) and by the full length of the cylinder (FIG. 2). And any of the components of which will be explained in the following section is contained in each of the three sections consisting the cylinder to ensure the balance of the cylinder on its axis assuming similar conditions and positions of these parts and components and each of these sections is presenting an independent unit. These components per unit are as follows:

### 1-A) Air Tank:

Air tanks is surrounding the internal cylinder (line 3 in FIG. 3) and it can be resized so that it can be fully deflated of air or be filled with the required magnitude of air while maintaining its shape and dimensions, the air tank Consists of the upper and lower sides which are made of inflexible materials and the other four sides are made from flexible material as much as possible and are not extendable to keep maintaining the dimensions and measures of the tank. The heights of the tank is equal to the loads movement distance; The length of the tank will be determined according to the tank magnitude and the width of the air tank is equal to one third (⅓) of the outer diameter of the internal cylinder (Adequate space is left if necessary between the tanks to allow the movement of the valve's arm 2 for opening and closing valves as will be explained in 1-C-3 of section 1) (line 6 in FIG. 4).

1-A-1) First side: it's the outer surface of the internal cylinder and its Inflexible sides (line 4 in FIG. 4), so that the width of the tank is equal to one third (⅓) of the outer circumference of the cylinder (three tanks) and it's the only constant side.
1-A-2) The second side: a moving side parallel with the outer surface of the internal cylinder (First side); this side is fully compatible with the first side in terms of shape, size and degree of bend of the outer surface of the first side and made from Inflexible materials also so that in the case of air vacuuming the air tank first and second Inflexible sides are completely identical (line 5 in FIG. 4), so there is no air between them.
1-A-3) Four other sides: they joint between the first and second Inflexible sides surrounding the four sides of the Inflexible sides of air tank, which is made of flexible material, or parts of it (not expandable) like bellows to allow the movement of the second Inflexible side in parallel with the first Inflexible side away from the axis of the cylinder (if the tank is opened and air is entered) and approaching of the axis of the cylinder and in compatible with the first side (the case of closure and vacuum)

### 1-B) Load:

It preferably be a higher density material and solid (iron-lead-mercury) to reduce the space occupied by the loads. It could take many forms as well (spherical-triangle-cylindrical as in this design); but a center must be set for each load.

These loads are placed separately from each other at the axes of the Internal cylinder (one load for each unit) so that the axes of these loads are identical with the axis of the Internal cylinder (line 8 in FIG. 3 and in FIG. 6B) (in the case of closed tanks and dump fully air), and each of them are carried and set on a pole prolonged from the load itself and passes through a hole in the middle of the first wall of the air tank (the cylindered body of the Internal cylinder), reaching the middle width of the second wall of the air tank and installed on it completely (line 9 in FIG. 5 and in FIG. 3). Namely that:

The distance between the center of load and the second wall of the air tank (fixed distance)=distance between the axis of the cylinder and the second wall of the air tank (in the case of close air tank and vacuum) and:

And the distance between the center of the load and the axes of the internal cylinder=the heights of the air tank (in case of open air tank).

Poles starting from loads centers divide the internal cylinder into three equal sections and each of them moves freely from each other (FIG. 2).

loads must move in a straight line unswervingly and with no deviation from the path line between the center of the cylinder and the center of the second wall of the tank and that by the passage of the pole through tube which is set on the inner side of the cylinder and it must allow easy movement of the pole with the lowest much power as possible for that.

Resizable Insulator also must be set on the pole between the load and the internal cylinder to allow the entry and exit of the pole without leakage of air out of the tank (line 10 in FIG. 3 and in FIG. 5) and to allow easy movement and with the lowest possible power.

Angles among load's pole must=120° (FIG. 2).

### 1-C) Valve:

The valve controls the entry and exit of air to and from the air tank. It's located and installed inside the internal cylinder on its cylindered body, and face up the unit air tank and linked to the air tank through a hole in that cylindered body (FIG. 20) the diameter of the valve must allow adequate flow of air.

The valve consists of the following:
1-C-1) Valve body: it's a tube with wide flat flange from the top. And the base is installed on the body of the internal cylinder from inside facing a hole opened to the unit air tank (line 11 in FIG. 20).

This tube is connected to fixed (L) shaped carrier arm facing the cylinder axis (line 12 in FIG. 20). At the end of this arm there is a hole to be used in installing the arm 1.

1-C-2) Arm 1: it's a moving arm and connecting the valve piston and the arm 2 and installed on the fixed (L) shaped carrier valve arm at the middle of the arm 1 (line 13 in FIG. 20).
1-C-3) Arm 2: (line 14 in FIG. 20) the arm connecting the arm (1) and the path on the external cylinder (will be explained later in the external cylinder paragraph 2 of section 1) and this arm passes through the internal cylinder body in the distance between the air tanks (if necessary). A wheel is installed at the end of the arm (line 25 in FIG. 7 and FIG. 20) which interact with the external cylinder at the valves control path to easily slide the arm around the perimeter of the external cylinder (line 14 in FIG. 7 and FIG. 20).
1-C-4) Piston: (line 15 in FIG. 20) it's a cover over the wide flat flange to close the valve and open it. It has the same surface shape and size of the wide flat flange of valve body and they are identical and covered with rubber on the side that faces the valve body, the other side has a head connected to the arm 1 (line 15 in FIG. 7 and FIG. 20).
1-C-5) spring: (line 16 in FIG. 20) the spring is installed between the (L) shaped arm of the valve body and the arm 1. It must have the ability to open the piston of the valve under the air Pressure (line 16 in FIG. 7 and FIG. 20).
Tube is installed on the passage of the arm 2 from the inner side of the internal cylinder on the cylindered body (line 26 in FIG. 20) so the arm 2 will be moving in a straight line and fixed unswervingly and must allows easy movement using the lowest possible power. Resizable Insulator must also be set between the arm 2 and the inner cylinder body to allow the entry and exit of the arm without leakage of air out or leakage of water in the internal cylinder (line 17 in FIG. 7 and FIG. 20) and must allow easy movement using the lowest possible power.

### 2—External Cylinder:

The external cylinder containing the entire internal cylinder and it's constant and has a base to be set on. Front and rear mouth of the external cylinder is parallel and perpendicular on the body of the cylinder and closed with two solid wells (line 18 in FIG. 8). Two hubs of this cylinder are constructed on the walls from inner side (line 19 in FIG. 8) and at the center of the external cylinder axis to be connected to the internal cylinder hubs in its solid walls (FIG. 9). This cylinder is divided theoretically, not actually in two halves by the length of the perpendicular diameter starting at the base line of the cylinder (line 20 in FIG. 11). The diameter of the internal cylinder is determined according to equation 2 and 3 of section 2and the components of the external cylinder are:

2-A) Valves control path: It is on the inner perimeter of this cylinder from inside. This is the path of the valve arm 2. It is in charge of transmission the action to open and close valves. The path is a cavity in the inner perimeter of the cylinder which the depth allows opening air valve, either in the case of closing the air valve there will be no cavity. The valve control path Width is perfect for the arm 2 wheel without twisting the arm 2 and is appropriate to ease its movement and stability (line 21 in FIG. 11, FIGS. 10A & B, FIG. 8, FIGS. 12 A & B).
The path is ranging gradient of this cavity in the longest possible distance when the trend of arm 2 is from the point of opening the valve to the point of closing the valve and commensurate with the air flow, and at the point which is to open the valve the cavity will be sharp decline.
2-B) Protrusion: protrusion is in the cylinder from the inside and its magnitude and space is equal to an open air tank space (line 22 in FIGS. 12A & B, FIG. 11). This protrusion is corresponds to the internal cylinder and facing the air tanks area; its thickness is constant at all points except for the path of the arm 2 of the valves (If the path is in that area).The Protrusion area must be over closed air tank at the point when a unit cycle start and another unit cycle ends. So in this area only a closed air tank can pass through.
2-C) Water container: the cylinder is connected to the water container (line 23 in FIG. 11, FIGS. 10A & B, FIG. 8, FIG. 12A & B) at the highest point of the cylinder through a pipe (line 24 in FIG. 11, FIGS. 10A & B, FIG. 8, FIGS. 12A & B), to fill the gap between the two cylinders by fresh water and to reserve the rest of the water over the cylinder. (The magnitude of the water container will be determined according to the equations of the invention number 1 in section 2).

### 3—Assembling the Components of the Invention:

1—The internal cylinder will be put inside the external cylinder with one air tank filled with air (equation number 4 in Section 2).
2—Closing the external cylinder with the two solid walls and the two hubs of the internal cylinder will be installed on the external cylinder hubs (FIG. 9).
3—Filling the water inside the external cylinder from the water container and according to the equation number 1in Section 2).

### Section 2: Basic and Essential Equation for the Invention:

1—The impact and weight of water on the air tank A at the beginning of the unit cycle (water located between the two cylinders over the air tank level and in the water container) must be less than the impact and weight of the two units loads (unit A and B in FIG. 13) with open valves to open the air tank A (Taking in Consideration the incline of the pole carrying the loads when calculating these loads impact and also considering the loads diameter).
2—The direct distance between the air tank A and the internal cylinder axis must generate torque of buoyancy energy on the internal cylinder axes greater than the generated torque from the deviation of the load A considering the longest direct distance between the center of the load A deviation and the internal cylinder axis and also considering the loads diameter (FIG. 13).
3—The removed water over the air tank A from the beginning to the end of unit cycle must have weight and effect on the axis of the internal cylinder (considering the distance between the air tank A and the internal cylinder axis which is the horizontal distance and parallel to the base line) more than the weight and effect of the deviation of the load A on the axis of the internal cylinder (considering the distance between the center of the load A deviation and the internal cylinder axis which is the horizontal distance and parallel to the base line and also considering the loads diameter).
4—The air magnitude inside the internal cylinder is equal to the interior space of the cylinder and one air tank filled with air (taking into account the change in temperature and atmospheric pressure).
5—The weight effect of the water located over the level of the opened air tank A between the two cylinders and in the water container at the ending point of unit A cycle (minus) the weight resulting from the deviation of the load A from the axis of internal cylinder is the minimum energy will be produced by the invention.

### Section 3: Explaining the Operation Cycle of the System

Initially a starting point is assumed which is the beginning point of a unit cycle. And the statues of each unit and each part within the unit will be stated separately for the three units. Then the operation cycle and interaction between units and its parts will be explained for the full stages and phases of the operation cycle of one unit. And by the end of the operation cycle the statues of the units and its parts will be stated again and by the rotation of the unit cycle three times the whole system will make a complete cycle.

### A—The Assumption of the Starting Point:

A-1) Assuming the beginning point of operating cycle of the unit (A) (FIG. 13):
A-2) The external cylinder is divided into two halves by the line (line 20 in FIG. 14) along the perpendicular diameter from the base line of the cylinder passing through the axis of the cylinder reaching the highest point of the cylinder. The highest point of the cylinder will be assumed point of angle (0°), and also point of angle (360°) for the diameter of the external cylinder. The internal cylinder is moving clockwise.

### B—The Statues of the Invention at Beginning Point of Operating Cycle of the Unit (A):

B-1) The angle point of 190° degree is at the line passes along in the middle width of the second wall of air tank (A) and it's the point of installing the load pole of unit (A) into the second wall of the air tank. The line passes along in the middle width of the second wall of air tank (B) is to be at the angle of 310°. And the line passes along in the middle width of the second wall of air tank (C) is to be at the angle of 70° (FIG. 14).
B-2) The valve of air tank (A) is open. The valve of air tank (B) is open. And the valve of air tank (C) is closed according to the valve control path (FIG. 13 & FIG. 14).
B-3) Air tank (A) is filled with air because of the pressure of load (A) to open the air tank (A) and the pressure of load (B) to close air tank (B) (equation#1 in section 2). And air tank (C) is empty (FIG. 13 and FIG. 14).
B-4) The center of load (A) is deviated from the axis of the two cylinders. The center of load (B) and load (C) is at the exact axis of the two cylinders, and in perfect balance with the internal cylinder in particular (FIG. 13 and FIG. 14).

### C—Phases of Operation Cycle of Unit (A)

C-1) The starting point of operating cycle for unit (A) has gust started by opining the unit valve and filling the unit air tank with air instead of air tank (B) and because of the impact of lode (A) and (B) it will stay open according to (equation#1 in section 2) (FIG. 13 and FIG. 14).

### C-2) Because of:

1. The direct distance between the air tank (A) and the internal cylinder axis generate torque of buoyancy energy on the internal cylinder axes greater than the generated torque resulted from the deviation of the load (A) considering the longest direct distance between the center of the load A deviation and the internal cylinder axis and also considering the loads diameter (equation#2 in section 2).
2. The removed water by the air tank (A) from the beginning to the end of unit cycle have weight and effect on the axis of the internal cylinder (considering the distance between the air tank (A) and the internal cylinder axis which is the horizontal distance and parallel to the base line) more than the weight and effect of the deviation of the load (A) on the axis of the internal cylinder (considering the distance between the center of the load (A) deviation and the internal cylinder axis which is the horizontal distance and parallel to the base line and also considering the loads diameter) (equation#3 in section 2).
   The internal cylinder will start to rotate about its axes clockwisely.
   Note: units (B and C) have no effect on the internal cylinder's balance because:
1—The center of loads (B and C) is identical with the internal cylinder axes and in perfect balance with the internal cylinder.
2—The air tanks (B and C) are empty of air.
   So the applying of equation # 2 and 3 will be for unit (A) only.
   C-3) When air tank (B) reaches angel (350°) the valve (B) of the air talk (B) will be closed (FIG. 16) by the valve control path because:
   C-3-1) The change of the inclination of loads pole (A) and (B) which could weaken the impact of loads on air tank (A) and the water pressure could reopen air tank (B).
   C-3-2) A big part of air tank (B) has become under the Protrusion area in the other half of the external cylinder, so air tank (B) must be empty and its valve be closed.
   C-4) When air tank (A) reaches the point (310°) (which was air tank (B) position in the beginning of the unit (A) operation cycle, the air tank (C) will be in the point (190°) and the valve of air tank (C) will be opened (FIG. 17).
   C-5) Once the valves of air tank (A) and (C) are open and the air tank (A) is at angle point 310° the air tank (A) will start to transfer the air to air tank (C) (FIG. 18) because of (equation # 1 in section 2):
   C-5-1) The pulling of load (A) on the second wall of air tank (A) to close the air tank which cause a pressure of air on air tank (C) (FIG. 18).
   C-5-2) The presser over the second wall of air tank (C) caused by load (C) to open the air tank (C) will cause air suction into air tank (C) from air tank (A) (FIG. 18).
   C-6) When the air tank (A) are fully empty of air, the effect of unit (A) on the balance of the internal cylinder will be ended, and the air tank (C) will be filled with air and the operation cycle of unit (C) will be gust started and so on.

### D—The Statues of Each Unit and its Parts at the End of Operation Cycle of Unit (A):

D-1) The angle point of 190° is at the line passes along in the middle width of the second wall of air tank (C) and it's the point of installing the load pole of unit (C) into the second wall of the air tank. The line passes along in the middle width of the second wall of air tank (A) is to be at the angle of 310°. And the line passes along in the middle width of the second wall of air tank (B) is to be at the angle of 70° (FIG. 19).
D-2) The valve of air tank (C) is open. The valve of air tank (A) is open. And the valve of air tank (B) is closed according to the valve control path (FIG. 19).
D-3) Air tank (C) is filled with air because of the pressure of lode (C) to open the air tank (C) and the pressure of lode (A) to close air tank (A) (equation#1 in section 2). And air tank (B) is empty (FIG. 19).
D-4) The center of load (C) is deviated from the axis of the internal cylinders. The center of load (A) and load (B) is at the exact axis of the two cylinders, and in perfect balance with the internal cylinder (FIG. 19).
D-5) The internal cylinder rotated about its axis 120° degrees (FIG. 19) and by the rotation of the unit operation cycle for two times more the internal cylinder will make a complete cycle.

### Section 4: The Relationships Among the Parts of the Invention

1—The air tank valve, air tank and load-related are representing one unit, each unit has a cycle. And the cycle begins for each of the three units by opening the valve and ends by closing of the air tank. Which mean that the unit cycle is managed by the valves control path on the external cylinder which manages the opening and the closing of the valve; Thus, each unity has a complete cycle, which will mean that one cycle of the internal cylinder is divided into three cycles of the three units which are sequential.
2—The control of the movement of loads and air tanks are related through the opening and closing of air valves for each unit.
4—The unit cycle can not be completed until another unit starts a new cycle and at the same time and vice versa.
5—The internal cylinder is completely isolated from the external cylinder and the outer atmosphere so that it does not leak out the air from the internal cylinder and do not enter the water surrounding it.
6—loads movement along it's path must be in the shortest distance as possible to minimize the effect of load deviation from the loads center, which affects on the balance of the internal cylinder and this distance must be proportional to the distance between the axis of the internal cylinder and the air tank (diameter of the internal cylinder) and also must be proportional as well with the load diameter itself.
7—The distance between the two cylinders must be reduced and from all sides to reduce the magnitude of water located between the two cylinders and places the largest possible magnitude of water in the water container at the top of the external cylinder and considering the equations of 1, 2, 3 and 5 in section 2.
8The internal cylinder must be in perfect balance assuming similar conditions of the three units (assuming dump all air tanks or filling all air tanks).

What I claim as my invention is:

1- An Apparatus and a method to generate perpetual energy from gravity or any other energy with the same effect on a rotary cylindrical system divided into an equal unit and comprising of three subsystems (loads, middle and liquid) and utilizing the effect of gravity on Weight and density of materials used. The system is mainly aiming to transform the gravity energy to buoyancy energy and making the effect of the buoyancy energy grater than the effect of gravity energy on the balance of the whole system by placing the center of the loads as a subsystem approximately or identical with the axes of the cylindrical system to reduce the gravity effect on the balance of the cylindrical system to zero or approximately zero when the loads are not on place to be effecting on the balance of the whole system and when the loads are on place to be effecting on the balance of the whole system it transfers the required magnitude of gravity energy directly from the center of the system (by little small load deviation from the cylinder axes and small effect on the balance of the system) to the middle subsystem at the circumference of the system whereas the middle subsystem will interact with the liquid subsystem and will be removed up over the middle subsystem to produce buoyancy energy and according to the distance between the axes of the system and the circumference of the system the effect and torque of the buoyancy energy will be grater than the effect and torque of the loads subsystem deviation on the balance of the whole system and the overbalance energy produced will rotate the loose cylindrical system about its axes.

2- An Apparatus and a method to generate perpetual energy as claimed in claim 1 in which the axes of the whole system is used to:
A—Receive the effect of the gravity energy and transport the energy directly from the center of the whole system to the circumference of the whole system and vise versa.
B—Reduce the effect of the gravity on the balance of the whole system to zero or approximately zero by placing loads subsystem at the axes of the system.

3- An Apparatus and a method to generate perpetual energy as claimed in claim 1 or 2 in which applying the three equations of:
A—The loads subsystem impact and weight on the middle subsystem is greater than the impact and weight of the liquid subsystem considering the incline effect of the loads subsystem.
B—The direct distance between the middle subsystem and the axis of the system must generate torque of buoyancy energy on the axes of the system greater than the generated torque from the deviation of the loads subsystem considering the longest direct distance between the center of the load deviation and the axis of the system and also considering the loads diameter.
C—The removed liquid (fluid) by the middle subsystem and over the middle subsystem from the beginning to the end of unit cycle must have weight and effect on the axis of the system (considering the distance between the middle subsystem and the system axis which is the horizontal distance and parallel to the base line) more than the weight and effect of the deviation of the loads subsystem on the axis of the system (considering the distance between the center of the loads deviation and the axis of the system which is the horizontal distance and parallel to the base line and also considering the loads diameter).

4- An Apparatus and a method to generate perpetual energy as claimed in one of claims 1-3 in which the system is mainly aiming to transform the gravity energy to buoyancy energy and making the effect of the buoyancy energy grater than the effect of gravity energy on the balance of the whole system by the interaction between three subsystems:
A—The loads subsystem: where's at the center of the whole system and it should be a very high density material (Ex. Iron); But it must weight more than the liquid subsystem. The loads subsystem receives the gravity effect and transfers it directly to the middle subsystem at the circumference of the system.
B—The liquid subsystem: This is a liquid (fluid) and its density must be higher than the density of the middle subsystem (Ex. Water).
C—The middle subsystem: it can be tangible or intangible material (Ex. air) and should have the lowest density and weight to float in the liquid subsystem. It links and interacts with the two other subsystems by receiving the direct effect from the loads subsystem caused by gravity and removing some of the liquid subsystem to create the buoyancy energy.

5- An Apparatus and a method to generate perpetual energy as claimed in one of claims 1-4 in which the whole system has one center only and comprising of two cylinders which are:
A—Internal cylinder: contain the loads subsystem and air tanks or the middle subsystem. and the internal cylinder is inside the external cylinder and the internal cylinder and the external cylinder are sharing and having the same axes in which are connected at to/and enable the internal cylinder to rotate about its axes while the external cylinder have a fixed base.
B—External cylinder: contain the internal cylinder and contain the liquid (fluid) subsystem surrounding the internal cylinder and storing the liquid on the top of the perpendicular diameter starting from the base line of the cylinder which is set according to the used energy effect direction.

6- An Apparatus and method as claimed in claim 1 in which the gravity energy could be replaced by any other energy or forces that have the same effect of the gravity on the balance of the whole system.

7- An Apparatus and method as claimed in claim 5 in which the external cylinder base line is perpendicular at the last point of the hypothetical line passing through the axes of the system and parallel with the energy used direction.

8- An Apparatus and method as claimed in claim 1 in which can be used or utilized in any place on the universe.

9- An Apparatus and a method to generate perpetual energy as claimed in claim 5 in which the internal cylinder is divided into an equal units and each unit has an operation cycle which starts from the unaffecting status on the balance of the system passing through the effecting status and returning to unaffecting status again in the end of the unit cycle and each unit have the same tangible components which have the functions of:
A. Controlling gadget: controlling the function and the interaction of middle subsystem between the loads subsystem and the liquid subsystem.
B. Loads subsystem: is the receiver of the energy and connected to the middle subsystem and exchanging the effect of the energy by gadget to transfer the energy effect through the distance between the two subsystems of each unit.
C. Middle subsystem: is interacting between the liquid subsystem and loads subsystem to produce the buoyancy energy using the effect of energy used on the loads and liquid subsystems.
D. Energy transferring gadget: it transfer the energy between the middle subsystem and the receiver of the energy.
